(19) United States
(12) Patent Application Publication
(10) Pub. No.: US 2017/0139125 A1
(43) Pub. Date: May 18, 2017

(54) DISPLAY MODULE

(71) Applicant: SHENZHEN CHINA STAR OPTOELECTRONICS TECHNOLOGY CO., LTD., Shenzhen, Guangdong (CN)

(72) Inventor: Yanxue ZHANG, Shenzhen, Guangdong (CN)

(73) Assignee: Shenzhen China Star Optoelectronics Technology Co., Ltd., Shenzhen, Guangdong (CN)

(21) Appl. No.: 14/426,744

(22) PCT Filed: Nov. 21, 2014
(86) PCT No.: PCT/CN2014/091916

§ 371 Date: Mar. 7, 2015

(30) Foreign Application Priority Data
Nov. 18, 2014 (CN) 201410660441.4

(51) Int. Cl. F21V 8/00; G02F 1/1333

(52) U.S. Cl. CPC G02B 6/0091; G02F 1/133308; G02B 6/0055; G02F 2001/133317

(57) ABSTRACT

The present invention discloses a display module, which includes a liquid crystal panel, optical films, a light guide plate, and a LED module. The LED module includes a vertical board and a horizontal board. The horizontal board has a lower surface in tight engagement with an upper surface of the light guide plate. The liquid crystal panel is fixed to an upper surface of the horizontal board and an upper surface of the optical films. The present invention provides an arrangement where the LED module is designed to include a vertical board and a horizontal board connected together; a lower surface of the horizontal board is in tight engagement with an upper surface of the light guide plate; and the liquid crystal panel is fixed on an upper surface of the horizontal board and an upper surface of the optical films.

### BACKGROUND OF THE INVENTION

1. Field of the Invention

The present invention relates to the field of display technology, and in particular to a display module.

2. The Related Arts

In the designs of televisions, mobile communication products, and products of table computer, the general consumers are increasingly showing favors to display devices of enlarged sizes. Manufacturers of the display devices are forced to work outs various solutions for effecting integrated designs of display module.

However, most of the design solutions that are currently available in the markets to achieve ultra-slim bezels are made in such a way that pawls are formed on sidewalls of a backplane, while retention holes that mate the pawls are formed in corresponding portions of a mold frame for the purposes of fixing the mold frame. Although providing effective fixing of internal components of a display device, such a solution makes the manufacturing art very complicated and thus increases the manufacturing costs.

### SUMMARY OF THE INVENTION

In view of the shortcomings of the known techniques, the present invention aims to provide a display module that features simplified technical art, low manufactured costs, and being highly integrated.

To achieve the above object, the present invention provides the following technical solution:

A display module comprises a liquid crystal panel, optical films, a light guide plate, and a light-emitting diode (LED) module. The LED module comprises a vertical board and a horizontal board. The horizontal board has a lower surface in tight engagement with an upper surface of the light guide plate. The liquid crystal panel is fixed to an upper surface of the horizontal board and an upper surface of the optical films.

Wherein, the display module further comprises a curved backplane. Lower surfaces of the light guide plate and the vertical board are set in tight engagement with a horizontal portion of the backplane. The backplane has a vertical portion that is arranged to have a height corresponding to a height of the vertical board of the LED module. The liquid crystal panel has a portion that is set on an upper surface of the vertical portion of the backplane.

Wherein, the display module further comprises a mold frame. The mold frame is positioned against the vertical portion of the backplane and has a lower end set on the horizontal portion of the backplane.

Wherein, the mold frame is arranged to have the same height as the vertical board and has an upper end positioned against the lower surface of the horizontal board.

Wherein, the light guide plate comprises a body portion and an extension portion. The extension portion has a bottom surface that is identical to that of the body portion and has a height less than that of the body portion. The lower surface of the vertical board is set in tight engagement with the extension portion.

Or, alternatively, the display module further comprises a mold frame and the mold frame has a lower end fixed on the extension portion and the mold frame has an upper end positioned against the lower surface of the horizontal board.

Wherein, the display module further comprises a mold frame. The mold frame has a lower end fixed on the extension portion. The mold frame has an upper end positioned against a lower surface of the liquid crystal panel.

Wherein, the display module further comprises a bonding layer. The bonding layer has a surface bonded to a lower surface of the liquid crystal panel. The bonding layer has an opposite surface bonded to the upper surface of the horizontal board and also bonded to a portion of the upper surface of the optical films.

Wherein, the backplane is formed by subjecting one surface of a raw material to polishing to increase roughness, followed by mirror surface processing to form an upper reflection surface, and then being subjected to stamping for shaping.

Or, alternatively, the light guide plate has a bottom surface that is plated with silver to form a lower reflection surface.

The present invention provides an arrangement where the LED module is designed to include a vertical board and a horizontal board connected together; a lower surface of the horizontal board is in tight engagement with an upper surface of the light guide plate; and the liquid crystal panel is fixed on an upper surface of the horizontal board and an upper surface of the optical films so as to make the structure of the display module more compact and the technical art used is made easy to effectively lower down the manufacture cost.

### BRIEF DESCRIPTION OF THE DRAWINGS

FIG. 1 is a cross-sectional view showing a portion of a display module according to a first embodiment of the present invention;

FIG. 2 is a cross-sectional view showing a portion of a display module according to a second embodiment of the present invention;

FIG. 3 is a cross-sectional view showing a portion of a display module according to a third embodiment of the present invention;

FIG. 4 is a cross-sectional view showing a portion of a display module according to a fourth embodiment of the present invention; and

FIG. 5 is a cross-sectional view showing a portion of a display module according to a fifth embodiment of the present invention.

### DETAILED DESCRIPTION OF THE PREFERRED EMBODIMENTS

The present invention will be further expounded with reference to embodiments of the present invention, in combination with the attached drawings.

### First Embodiment

As shown in FIG. 1, a schematic view is given to illustrate a structure of a display module according to a first embodiment of the present invention. The instant embodiment provides a display module that comprises a liquid crystal panel 10, optical films 20, a light guide plate 30, and an LED (Light-Emitting Diode) module 40. The LED module 40 comprises a vertical board 41 and a horizontal board 42. The horizontal board 42 has a lower surface that is partly set in tight engagement with an upper surface of the light guide plate 30. The liquid crystal panel 10 is fixed to an upper surface of the horizontal board 42 and an upper surface of the optical films 20.

In the instant embodiment, the display module further comprises a curved backplane 60. Lower surfaces of the light guide plate 30 and the vertical board 41 are set in tight engagement with a horizontal portion of the backplane 60. The backplane 60 has a vertical portion that is arranged to have a height corresponding to a height of the vertical board 41 of the LED module 40. The liquid crystal panel 10 has a portion that is set on an upper surface of the vertical portion of the backplane 60.

A bonding layer 70 has a surface that is bonded to a lower surface of the liquid crystal panel 10 and the bonding layer 70 has an opposite surface that is bonded to the upper surfaces of the vertical portion of the backplane 60 and the horizontal board 42 and is also bonded to a portion of the upper surface of the optical films 20.

The display module further comprises mold frame 50 arranged therein. The mold frame 50 has a lower end that is set on the horizontal portion of the backplane 60 and has a side positioned against the vertical portion of the backplane 60. Specifically, the mold frame 50 is interposed between a side of the horizontal board 42 of the LED module 40 and the vertical portion of the backplane 60. It is appreciated that in the instant embodiment, the mold frame 50 can be omitted so that the LED module 40 is set in direct engagement with the vertical portion of the backplane 60.

To enhance backlighting brightness of the display module, the horizontal portion of the backplane 60 is formed as a reflection surface showing an effect of mirror reflection. Specifically, the manufacture of the backplane 60 of the instant embodiment is as follows. One surface of a raw material is subjected to polishing to increase the roughness and the polished rough surface is subjected to mirror surface processing to form an upper reflection surface 60a. And, finally, stamping is applied to form the curved structure of the backplane. The mirror surface processing adopted in the instant embodiment can be a chemical operation of silver mirror reaction or an electroplating operation.

The instant embodiment provides an arrangement where the upper reflection surface 60a is integrally formed on the surface of the backplane 60, which, as compared to a conventional solution where a mirror-surface reflector plate is individually arranged, can be made more compact in structure so that the display module can be made thinner and the reflection surface is not susceptible to warpage or deformation that affects the displaying performance thereof and, as compared to reflector plate that is manufactured separately, requires technical art that is easier and cost that is lower.

### Second Embodiment

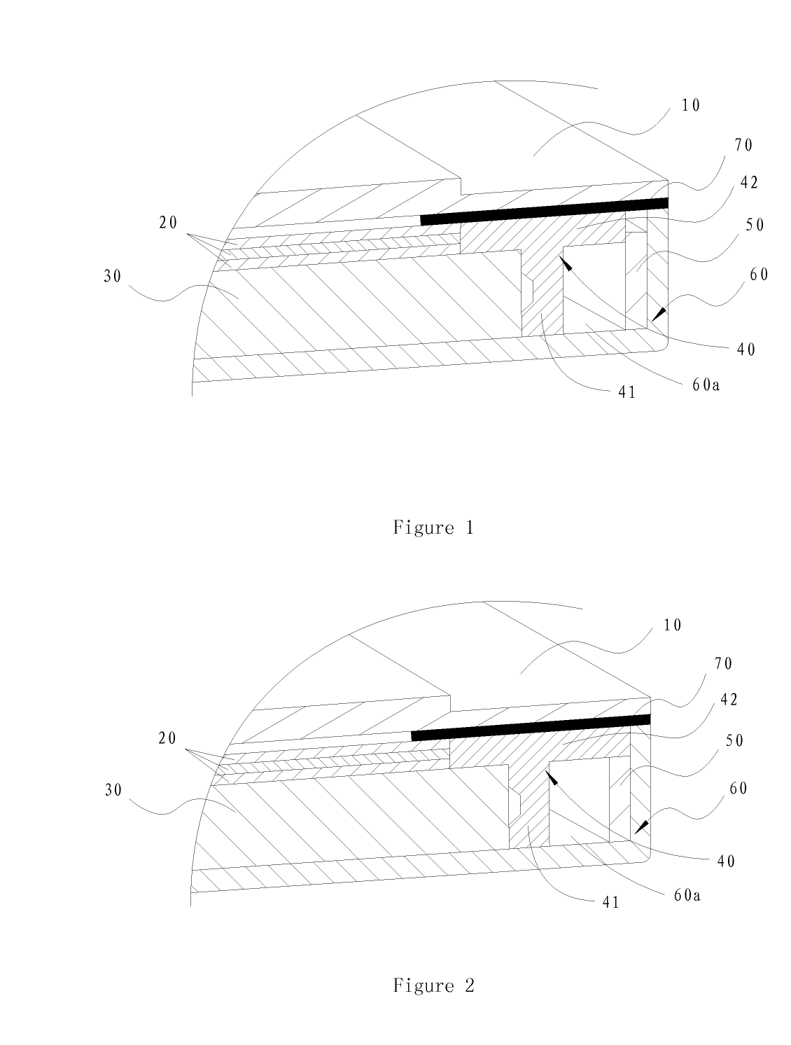

What are different from the first embodiment are the size and the arrangement of the mold frame 50 of the instant embodiment. As shown in FIG. 2, in the instant embodiment, the mold frame 50 is arranged to have the same height as the vertical board 41 and has a lower end set on the horizontal portion of the backplane 60 and an upper end positioned against the lower surface of the horizontal board 42. Here, the mold frame 50 also provides a function of additional supporting.

### Third Embodiment

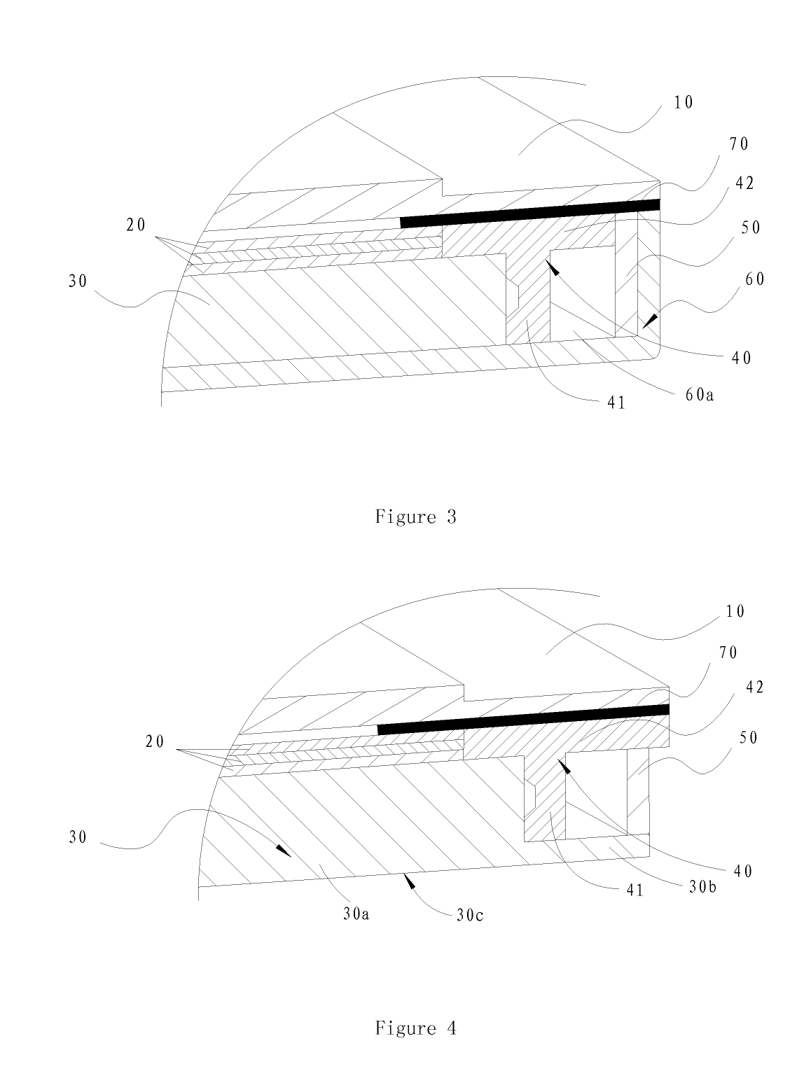

What are different from the first embodiment are the size and the arrangement of the mold frame 50 of the instant embodiment. As shown in FIG. 3, in the instant embodiment, the mold frame 50 is arranged to have the same height of the vertical portion of the backplane 60 and has a lower end set on the horizontal portion of the backplane 60 and an upper end bonded by the bonding layer 70 to the lower surface of the liquid crystal panel 10. Here, the mold frame 50 also provides a function of additional supporting. Correspondingly, one surface of the bonding layer 70 is bonded to the lower surface of the liquid crystal panel 10, while the opposite surface of the bonding layer 70 is bonded to the upper surfaces of the vertical portion of the backplane 60 and the horizontal board 42 and is also bonded to a portion of the upper surface of the optical films 20 and is also bonded to an upper end face of the mold frame 50.

### Fourth Embodiment

What is different from the first embodiment is that the display module of the instant embodiment comprises no backplane and the light guide plate 30 comprises a different light reflection structure on a bottom thereof.

As shown in FIG. 4, the light guide plate 30 provided in the instant embodiment comprises a body portion 30a and an extension portion 30b.

The extension portion 30b has a bottom surface that is identical to that of the body portion 30a and has a height less than that of the body portion 30a. The lower surface of the vertical board 41 is set in tight engagement with the extension portion 30b.

The lower end of the mold frame 50 is fixed on the extension portion 30b and the upper end of the mold frame 50 is positioned against the lower surface of the horizontal board 42 so that the mold frame 50 provides a function of additional supporting.

Correspondingly, one surface of the bonding layer 70 is bonded to the lower surface of the liquid crystal panel 10, while the opposite surface of the bonding layer 70 is bonded to the upper surface of the horizontal board 42 and a portion of the upper surface of the optical films 20.

To enhance backlighting brightness of the display module, the light guide plate 30 has a bottom surface that is plated with silver to form a lower reflection surface 30c. By integrally forming the lower reflection surface 30c on the bottom surface of the light guide plate 30, a structure of a backplane can be saved and the manufacturing cost can be reduced. As compared to a conventional solution where a mirror-surface reflector plate is individually arranged, the structure is more compact so that the display module can be made thinner and the reflection surface is not susceptible to warpage or deformation that affects the performance thereof and, as compared to reflector plate that is manufactured separately, the technical art required is easer and the cost is lower.

### Fifth Embodiment

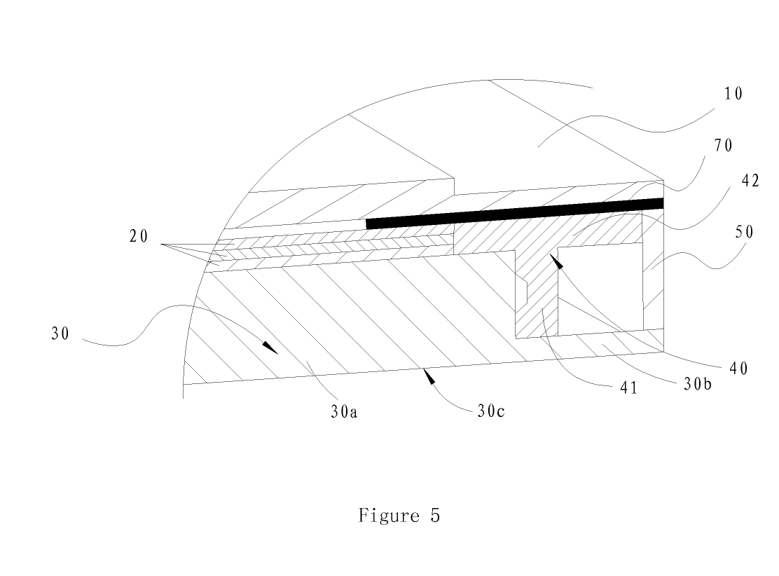

What are different from the fourth embodiment are the size and the arrangement of the mold frame 50 of the instant embodiment. As shown in FIG. 5, the lower end of the mold frame 50 is fixed on the extension portion 30b and the upper end of the mold frame 50 is positioned against the lower surface of the liquid crystal panel 10 so that the mold frame 50 provides a function of additional supporting. Correspondingly, one surface of the bonding layer 70 is bonded to the lower surface of the liquid crystal panel 10, while the opposite surface of the bonding layer 70 is bonded to the upper surface of the horizontal board 42 and a portion of the upper surface of the optical films 20 and is also bonded to the upper end face of the mold frame 50.

Some embodiments of the present invention have been described simply for the purposes of illustrating the present invention in order to make technical people of this field throughout understand the technical solution. It is, however, noted that for those having ordinary skills of the field of this art, various improvement and modifications are possible without departing the principle of the present invention and such improvements and modifications are considered falling in the protection scope of the present invention.

What is claimed is:

1. A display module, comprising a liquid crystal panel, optical films, a light guide plate, and a light-emitting diode (LED) module, the LED module comprising a vertical board and a horizontal board, the horizontal board having a lower surface in tight engagement with an upper surface of the light guide plate, the liquid crystal panel being fixed to an upper surface of the horizontal board and an upper surface of the optical films.

2. The display module as claimed in claim 1 further comprising a curved backplane, lower surfaces of the light guide plate and the vertical board being set in tight engagement with a horizontal portion of the backplane, the backplane having a vertical portion that is arranged to have a height corresponding to a height of the vertical board of the LED module, the liquid crystal panel having a portion that is set on an upper surface of the vertical portion of the backplane.

3. The display module as claimed in claim 2 further comprising a mold frame, the mold frame being positioned against the vertical portion of the backplane and having a lower end set on the horizontal portion of the backplane.

4. The display module as claimed in claim 3, wherein the mold frame is arranged to have the same height as the vertical board and has an upper end positioned against the lower surface of the horizontal board.

5. The display module as claimed in claim 1, wherein the light guide plate comprises a body portion and an extension portion, the extension portion having a bottom surface that is identical to that of the body portion and having a height less than that of the body portion, the lower surface of the vertical board being set in tight engagement with the extension portion.

6. The display module as claimed in claim 5 further comprising a mold frame, the mold frame having a lower end fixed on the extension portion, the mold frame having an upper end positioned against the lower surface of the horizontal board.

7. The display module as claimed in claim 5 further comprising a mold frame, the mold frame having a lower end fixed on the extension portion, the mold frame having an upper end positioned against a lower surface of the liquid crystal panel.

8. The display module as claimed in claim 1 further comprising a bonding layer, the bonding layer having a surface bonded to a lower surface of the liquid crystal panel, the bonding layer having an opposite surface bonded to the upper surface of the horizontal board and also bonded to a portion of the upper surface of the optical films.

9. The display module as claimed in claim 2, wherein the backplane is formed by subjecting one surface of a raw material to polishing to increase roughness, followed by mirror surface processing to form an upper reflection surface, and then being subjected to stamping for shaping.

10. The display module as claimed in claim 5, wherein the light guide plate has a bottom surface that is plated with silver to form a lower reflection surface.

11. The display module as claimed in claim 2 further comprising a bonding layer, the bonding layer having a surface bonded to a lower surface of the liquid crystal panel, the bonding layer having an opposite surface bonded to the upper surface of the horizontal board and also bonded to a portion of the upper surface of the optical films.

12. The display module as claimed in claim 3 further comprising the bonding layer, the bonding layer having a surface bonded to a lower surface of the liquid crystal panel, the bonding layer having an opposite surface bonded to the upper surface of the horizontal board and also bonded to a portion of the upper surface of the optical films.

13. The display module as claimed in claim 4 further comprising the bonding layer, the bonding layer having a surface bonded to a lower surface of the liquid crystal panel, the bonding layer having an opposite surface bonded to the upper surface of the horizontal board and also bonded to a portion of the upper surface of the optical films.

14. The display module as claimed in claim 5 further comprising the bonding layer, the bonding layer having a surface bonded to a lower surface of the liquid crystal panel, the bonding layer having an opposite surface bonded to the upper surface of the horizontal board and also bonded to a portion of the upper surface of the optical films.

15. The display module as claimed in claim 6 further comprising the bonding layer, the bonding layer having a surface bonded to a lower surface of the liquid crystal panel, the bonding layer having an opposite surface bonded to the upper surface of the horizontal board and also bonded to a portion of the upper surface of the optical films.

16. The display module as claimed in claim 7 further comprising the bonding layer, the bonding layer having a surface bonded to a lower surface of the liquid crystal panel, the bonding layer having an opposite surface bonded to the upper surface of the horizontal board and also bonded to a portion of the upper surface of the optical films.

17. The display module as claimed in claim 3, wherein the backplane is formed by subjecting one surface of a raw material to polishing to increase roughness, followed by mirror surface processing to form an upper reflection surface, and then being subjected to stamping for shaping.

18. The display module as claimed in claim 4, wherein the backplane is formed by subjecting one surface of a raw material to polishing to increase roughness, followed by mirror surface processing to form an upper reflection surface, and then being subjected to stamping for shaping.

19. The display module as claimed in claim 6, wherein the light guide plate has a bottom surface that is plated with silver to form a lower reflection surface.

20. The display module as claimed in claim 7, wherein the light guide plate has a bottom surface that is plated with silver to form a lower reflection surface.
